(19) United States
(12) Patent Application Publication
(10) Pub. No.: US 2025/0008017 A1
(43) Pub. Date: Jan. 2, 2025

(54) Sending messages to all telephone and cellular utilities callers while waiting for the call to be answered or terminated

(71) Applicant: Elio B. Casamassima, The Bronx, NY (US)

(72) Inventor: Elio B. Casamassima, The Bronx, NY (US)

(21) Appl. No.: 18/679,198

(22) Filed: May 30, 2024

Related U.S. Application Data
(63) Continuation of application No. 18/190,603, filed on Mar. 27, 2023.

(51) Int. Cl. H04M 3/42

(52) U.S. Cl. CPC H04M 3/42017

(57) ABSTRACT

For all telephones, telephones with wireless, cell phones, wireless phones. The ADVERTISER receives the order, via 800 number and. corn site, specifying the order, area code, date, and the fee, Each ad will be posted between two ringing signals heard by the caller. Each ad has a duration of 4.5 seconds. Total time between two ringing signals heard by the caller is six seconds, in one minute, ten ads can be posted. If thirty messages are posted, each message will be heard every three minutes. The number of ads, messages, may vary. Saturdays, the advertiser sends the timely pertinent spaced messages to area code stations to be played the following week from Monday to Friday. Schedules can be changed. The area stations synchronize that they received the message with the ringing signals and repeat them in a loop. The advertisements are targeted to the population of each area code.

### CROSS-REFERENCE TO RELATED APPLICATIONS

This application is a continuation of a U.S. patent application Ser. No. 18/190,603 filed on Mar. 27, 2023, which claims priority from a U.S. Provisional Patent Appl. No. 63/474,546 filed on Aug. 24, 2022, both of which are incorporated herein by reference in its entirety.

### STATE OF THE ART

Modern Telephone and Cellular phones are very similar except the system of the transmitting of the signals. Telephone companies use physical copper wire while cellular companies use radio frequencies.

Much in common, Telephone and Cellular companies have switching systems, signal systems (systems includes ringing calls, busy signals).

### SUMMARY OF THE INVENTION

Sending messages to all telephone and cellular utilities callers while waiting for the call to be answered or terminated.

AH the users of telephones and cell phone services when they make the call they receive signals that the call has been made. These brief signals last until the call has been answered or terminated.

These calling signals are separated from each other for about 5 seconds. There are no frequencies in between these signals.

The recorded messages are timely equally spaced to fit each two ringing signals. The recorded timely spaced messages may be set on a closed loop or similar.

This invention uses the space between the signals to send messages that are heard by the caller. These spaces can be used to advertise products.

### BRIEF DESCRIPTION OF THE INVENTION

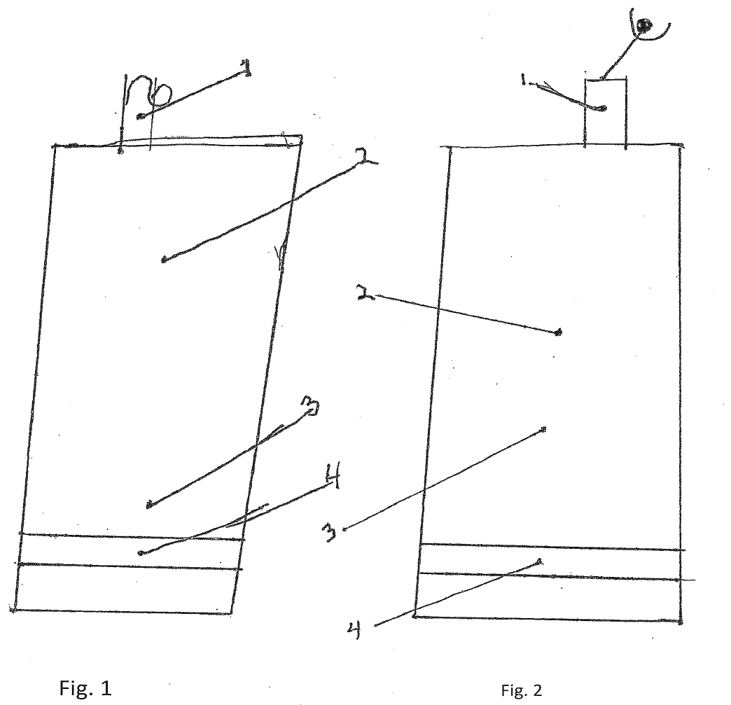

FIG. 1 shows a system used by telephone companies.

FIG. 2 shows the system for sending messages.

### DESCRIPTION OF THE INVENTION

Telephone companies use systems described in FIG. 1. In 1 FIG. 1, represents >the cable connecting all the telephones to the switching system located in 2 FIG. 1 There is a generator of two kind of signals and they are “Busy” line and “Ringing” calls. The ringing calls reach both caller as well as the called number.

Section 3 FIG. 1 is the section of the calling signal sent to the caller. The invention consists of a recorder 4 FIG. 1 that is activated by the short ringing signal and transmits a short brief message. This short message, of about, 5 seconds, is transmitted to the caller.

Cellular telephone companies use the system described in FIG. 2 where i FIG. 2 represents the antenna connecting cellular telephones to switching stations 2 FIG. 2. The ringing signals to callers are generated in 3 FIG. 2. The recorder 4 FIG. 2 Is activated by the ringing signal transmitted by the generator 3 FIG. 2 and sends a brief message of about 5 seconds to caller through 3 FIG. 2.

1. I claim the right to the use of sending messages to telephone and cellular callers between calling signals.

2. I reserve the right of sending the same message, of 5 seconds or less (10 messages each minute} repeated over and over to the phone caller by a closed loop tape or a simile repeating device.

3. I reserve the right of sending different messages to phone callers of 5 seconds or less (10 messages each minute). A particular message will be repeated every three minutes when we have 30 different messages. Loop tape recorders or similar devices will repeatedly transmit the same 30 message, or any chosen number.
